(19) United States
(12) Patent Application Publication
(10) Pub. No.: US 2022/0395839 A1
(43) Pub. Date: Dec. 15, 2022

(54) FOOD WASTE DISPOSAL APPARATUS

(71) Applicant: BOGANGST Co.,Ltd., Seongnam-si (KR)

(72) Inventor: Jung Hoon JANG, Goyang-si (KR)

(73) Assignee: BOGANGST Co.,Ltd.

(21) Appl. No.: 17/345,646

(22) Filed: Jun. 11, 2021

(51) Int. Cl. B02C 18/16; E03C 1/266; B02C 18/14; B02C 18/00

(52) U.S. Cl. CPC B02C 18/16; E03C 1/266; B02C 18/142; B02C 18/0092; B02C 2018/164

(57) ABSTRACT

Proposed is a food-waste disposal apparatus, in particular, including a housing; a plurality of grinding blades provided inside the housing and grinding food waste put into the housing; a grinding shaft mounted with the plurality of grinding blades at setting intervals and rotatably installed at one side of the housing; a grinding scraper comprising a plurality of scraper projections and preventing food waste from getting stuck between the grinding blades; and a scraper guide provided inside the housing, guiding the grinding scraper to turn to a mounting position, and supporting the grinding scraper in a mounting state, wherein the grinding scraper is mounted at the mounting position as turned along the scraper guide after the grinding scraper is laid on the grinding blades through an upper opening of the housing so that the scraper projections can be disposed between the grinding blades.

### BACKGROUND

### Field

The disclosure relates to a food-waste disposal apparatus, and more particularly to a food-waste disposal apparatus, in which it is easy to mount and detach the grinding scraper and it is possible to minimize time taken in mounting and detaching the grinding scraper because a grinding scraper is mountable and detachable without disassembling any element other than an upper cover, and a separate process or effort to lock the grinding scraper is not needed because the grinding scraper is firmly locked by coupling only the upper cover.

### Description of the related art

In general, a certain amount of food waste is thrown out daily at homes, restaurants, etc. and most of such food waste contains a lot of water. Therefore, there is a problem that disposal of the food waste without treatment leads to soil pollution and river pollution.

To solve this problem, there have conventionally been proposed a dehydration apparatus for removing only water from the food waste, technology of using a heater to remove water after microbial decomposition and agitation, etc., and there has recently been proposed a food-waste disposal apparatus that is connected to a sink drain of the home or restaurant, grinds dregs of food waste, and dehydrates and dries the ground food waste.

For example, Korean Patent No. 10-1760107, titled “APPARATUS FOR TREATING FOOD WASTE”, has been disclosed as a food-waste disposal apparatus to simplify a structure and an assembling process and facilitate maintenance in the state that the apparatus is being mounted.

However, when a grinding scraper 130 is broken down, the conventional food-waste disposal apparatus is required to detach a rear cover 213 and a front main-body housing, and then detach the grinding scraper 130 provided at the opposite sides of a grinding blade 251, as shown in the accompanying drawings (see FIG. 1) of the related art. Eventually, the whole food-waste disposal apparatus should be disassembled, thereby causing problems that a process is very complicated and it will take a lot of time.

On the other hand, when the conventional food-waste disposal apparatus is assembled, it is impossible to assembly a main body housing without locking the grinding scraper 130 to the grinding blade 251. Accordingly, a locking portion 217 for locking the grinding scraper 130 should be separately formed in the rear cover 213, and a projection 242 to be locked to the locking portion 217 should be separately formed in the grinding scraper 130, thereby causing problems of a complicated design and many processes.

### SUMMARY

An aspect of the disclosure is to provide a food-waste disposal apparatus, in which it is easy to mount and detach the grinding scraper and it is possible to minimize time taken in mounting and detaching the grinding scraper because a grinding scraper is mountable and detachable without disassembling any element other than an upper cover, thereby maximizing convenience.

Further, another aspect of the disclosure is to provide a food-waste disposal apparatus, in which downward movement of a grinding scraper is restricted by a stopper and upward movement of the grinding scraper is restricted by a locking projection of an upper cover as long as the upper cover is coupled in a state that the grinding scraper is mounted, thereby firmly locking the grinding scraper without any separate process for the locking.

In accordance with an embodiment of the disclosure, there is provided a food-waste disposal apparatus including: a housing; a plurality of grinding blades provided inside the housing and grinding food waste put into the housing; a grinding shaft mounted with the plurality of grinding blades at setting intervals and rotatably installed at one side of the housing; a grinding scraper including a plurality of scraper projections and preventing food waste from getting stuck between the grinding blades; and a scraper guide provided inside the housing, guiding the grinding scraper to turn to a mounting position, and supporting the grinding scraper in a mounting state, wherein the grinding scraper is mounted at the mounting position as turned along the scraper guide after the grinding scraper is laid on the grinding blades through an upper opening of the housing so that the scraper projections can be disposed between the grinding blades, or detached from the mounting state as turned in a reverse direction.

The grinding scraper may include a body, and the plurality of scraper projections extended from the body, and a back side of the body facing the scraper guide may be shaped corresponding to a guide surface of the scraper guide at the mounting position.

Here, the food-waste disposal may further include a stopper at one side of the scraper guide to prevent the grinding scraper from turning beyond the mounting position in a mounting direction.

Here, the grinding scraper may further include a head portion formed in an upper portion of the body facing the upper opening in the mounting state, the food-waste disposal apparatus may further include an upper cover formed with a food-waste inlet at an upper side, communicating with the upper opening, and detachably coupled to the upper opening of the housing so that food waste can be introduced into the housing, and the upper cover may include a locking projection at a lower side to prevent the head portion from moving, and prevents the grinding scraper from turning at the mounting position in a detaching direction.

Here, the housing may include an introducing portion formed at one side of the upper opening and inclined to facilitate introduction of food waste into the grinding blades, and the head portion may be formed with an inclined portion shaped corresponding to the introduction portion at the mounting position, and connected to the introducing portion in a state that the grinding scrapper is mounted.

In the foregoing embodiments, the grinding shaft may include two left and right grinding shafts provided inside the housing, and the scraper guide and the grinding scraper may be respectively provided corresponding to the grinding shafts.

In this case, the scraper guides may include guide surfaces different in shape from each other, and the grinding scrapers may include back sides respectively provided corresponding to the guide surfaces.

Meanwhile, the stopper may be provided in one or both of a lower end and a middle side of the body.

In this case, the stopper may include a stopper projection provided in one of the body and the scraper guide corresponding to the body, and a stopper-projection accommodating groove provided in the other one and accommodating the stopper projection.

Meanwhile, the body may include a front side facing the grinding blade and shaped like an arc to prevent interference with the grinding blade, and the back side shaped corresponding to the guide surface, and the plurality of scraper projections may protrude from a lower side of the body toward the grinding blade.

### BRIEF DESCRIPTION OF THE DRAWINGS

The above and/or other aspects will become apparent and more readily appreciated from the following description of embodiments, taken in conjunction with the accompanying drawings, in which:

FIG. 1 is a partial view for describing a process of mounting a grinding scraper of a conventional food-waste disposal apparatus;

FIG. 2 is an exploded perspective view of a food-waste disposal apparatus according to an embodiment of the disclosure;

FIGS. 3A-3B are perspective views of a grinding scraper according to an embodiment of the disclosure;

FIGS. 4 to 6 are views for describing a process of mounting a grinding scraper according to various embodiments of the disclosure;

FIG. 7 is a perspective view showing that a grinding scraper is mounted according to an embodiment of the disclosure; and

FIG. 8 is a perspective view showing a bottom side of an upper cover according to an embodiment of the disclosure.

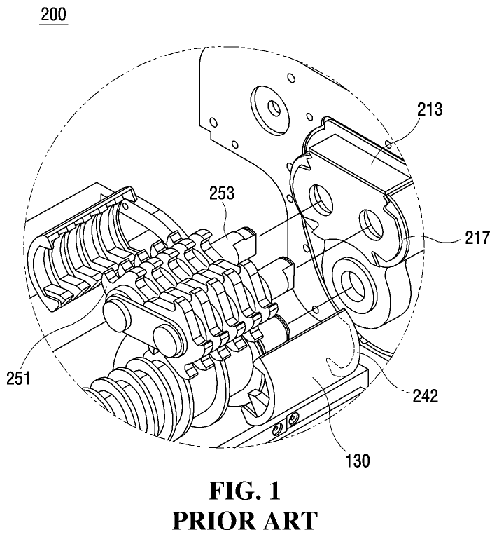

### DETAILED DESCRIPTION OF EMBODIMENTS

Below, embodiments of the disclosure will be described in detail with reference to the accompanying drawings.

Prior to description, the disclosure is not limited or restricted to embodiments set forth herein, and like numerals refer to like elements throughout so that descriptions can be made by referring to the elements shown in the other drawings. Further, descriptions obvious to those skilled in the art or repetitive descriptions may be omitted.

Further, a term ‘grinding’ in this specification may refer to ‘crushing’ and ‘grinding’ into which ‘grinding’ in a broad sense is classified according to the sizes of particles after grinding, but, in this specification, refers to the grinding in a broad sense regardless of particle sizes.

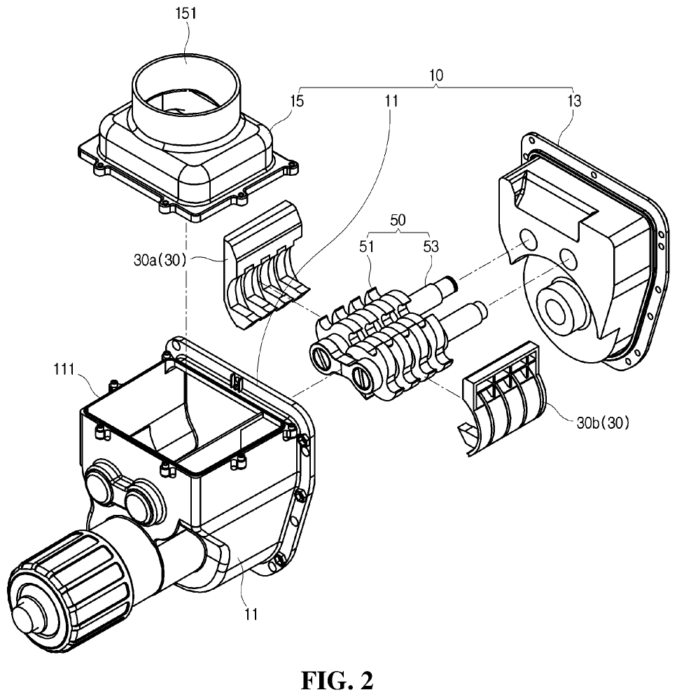

Referring to FIG. 2, a food-waste disposal apparatus 1 according to an embodiment of the disclosure includes a housing 10, a grinder 50 having a plurality of grinding blades 51, a grinding scraper 30 for preventing food waste from getting stuck between the grinding blades 51, and a scraper guide 17 for guiding the grinding scraper 30 to be settled.

Thus, the food-waste disposal apparatus 1 according to the disclosure has advantages of easily mounting and detaching the grinding scraper 30 through an upper opening 111 of the housing 10 without disassembling the whole housing 10.

Below, the elements will be described in detail.

The housing 10 forms an outer appearance of the food-waste disposal apparatus 1, and internally includes the grinder 50, a transfer screw 121, etc.

The housing 10 may be divided into two or more elements, for example, a main body housing 11, an upper cover 15, and a rear cover 13 as shown in FIG. 2.

The upper cover 15 is formed with a food-waste inlet 151 provided at an upper side and communicating with a sink, communicates with the upper opening 111 of the main body housing 11, and is detachably coupled to the upper opening 111 of the main body housing 11 so that food waste can be introduced into the main body housing 11.

The rear cover 13 is coupled to the back of the main body housing 11, and rotatably supports a grinding shaft 53 and the transfer screw 121. To this end, a driver (not shown) is provided in the back.

Therefore, in the food-waste disposal apparatus 1 according to the disclosure, food waste introduced through the food-waste inlet 151 of the upper cover 15 is ground by the grinder 50 in an upper portion of the main body housing 11, compressed by the transfer screw 121 in a lower portion, transferred in a frontward direction of the main body housing 11, and discharged.

In the following description of the housing 10, detailed elements shown in the accompanying drawings, in other words, the main body housing 11, the rear cover 13 and the upper cover 15 will be described as used mixed with one another.

The grinder 50 includes the grinding blades 51 and the grinding shaft 53.

The plurality of grinding blades 51 is provided inside the housing 10 and grinds food waste put into the housing 10.

The grinding shaft 53 is mounted with the plurality of grinding blades 51 at setting intervals as shown in FIG. 2, and is rotatably installed at one side of the housing 10, for example, in the rear cover 13.

The number of grinding shafts 53 may be varied. For example, as shown in FIG. 2, two grinding shafts 53 may be provided left and right inside the main body housing 11. Alternatively, three or more grinding shafts may be provided

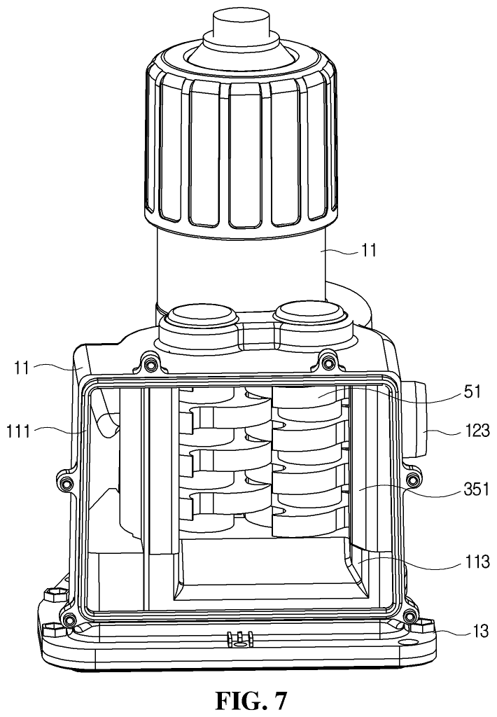

When two grinding shafts 53 are provided, as shown in FIG. 7 the grinding blades 51 respectively mounted to different grinding shafts 53 are alternately disposed between the opposite grinding blades 51.

In this case, the scraper guide 17 and the grinding scraper 30 to be described later may be provided corresponding to each grinding shaft 53.

Further, when a plurality of scraper guides 17 and a plurality of grinding scrapers 30 are provided, the scraper guides 17 may include guide surfaces 173 different is shape from each other, and a back side 311 of each grinding scraper 30 may be provided corresponding to each guide surface 173. In this regard, details will be described in a corresponding description.

The grinding scraper 30 includes a plurality of scraper projections 33, and prevents food waste from getting stuck between the grinding blades 51.

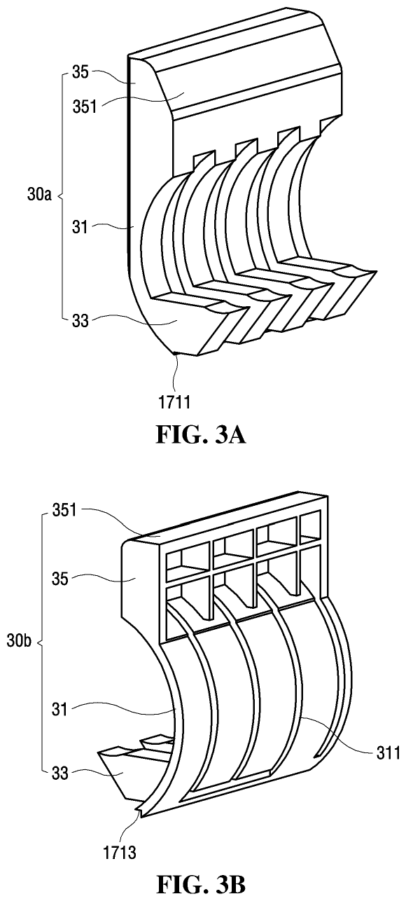

The grinding scraper 30 may for example include a body 31, the scraper projections 33, and a head portion 35 as shown in FIGS. 3A-3B.

The body 31 may have various shapes, in which, for example, as shown in FIGS. 3A-3B, a front side facing the grinding blades 51 may be shaped like an arc to prevent interference with the grinding blades 51, and the back side 311 may be shaped corresponding to a guide surface 173 of the scraper guide 17.

Meanwhile, when two grinding shafts 53 are provided as shown in FIGS. 2 and 3A-3B, two grinding scrapers 30 are correspondingly provided. The grinding scrapers 30 may have the same shape, but may have different shapes.

In terms of forming the scraper guide 17 inside the main body housing 11, the guide surfaces 173 of two scraper guides 17 may be different in shape according to their positions, in which the shape of the back side 311 of the body 31 is varied depending on the shape of each guide surface 173.

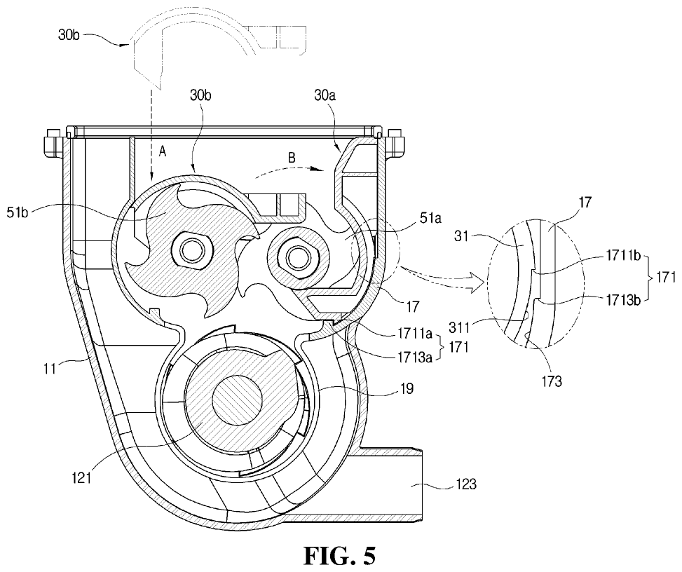

Specifically, the back side 311 (see FIGS. 3A-3B and 5) of the body 31 facing the scraper guide 17 may be provided corresponding to the guide surface 173 of the scraper guide 17 when the grinding scraper 30 is disposed at a mounting position.

However, the shapes of the back side 311 and the guide surface 173 do not have to correspond to each other throughout the grinding scraper 30 or the scraper guide 17, but may correspond to each other only in a part where the grinding scraper 30 is guided to turn and maintained at the mounting position.

The plurality of scraper projections 33 are extended from the body 31.

The scraper projections 33 may be formed at various positions of the body 31, and may for example protrude from a lower side of the body 31 toward the grinding blades 51 as shown in FIG. 3.

The head portion 35 is formed in an upper portion of the body 31 facing toward the upper opening 111 of the main body housing 11 in the mounting state.

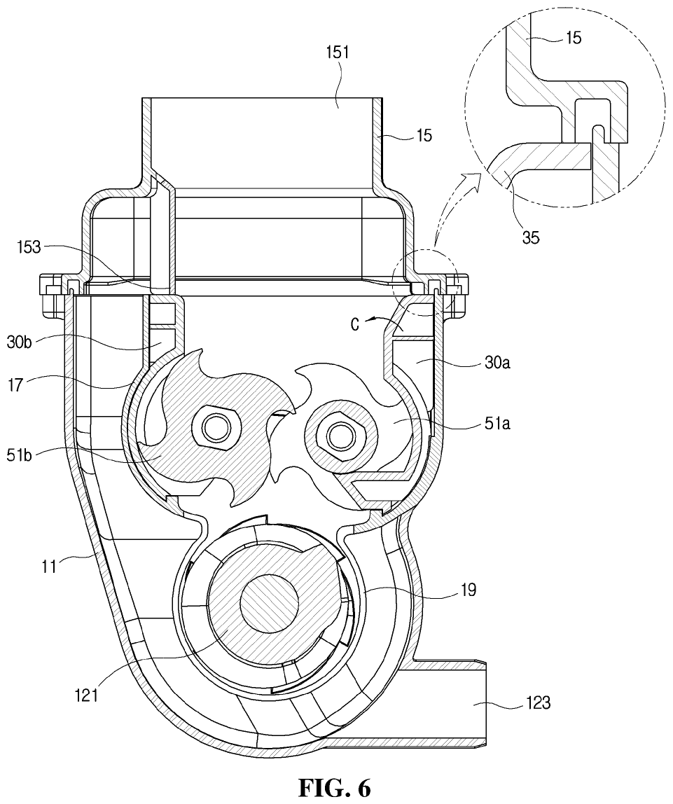

The head portion 35 may be provided to have various lengths, but as shown in FIG. 6 the whole or partial region of the head portion 35 may be provided to have a length to be in contact with a locking projection 153 provided in the upper cover 15 when the grinding scraper 30 is disposed at the mounting position.

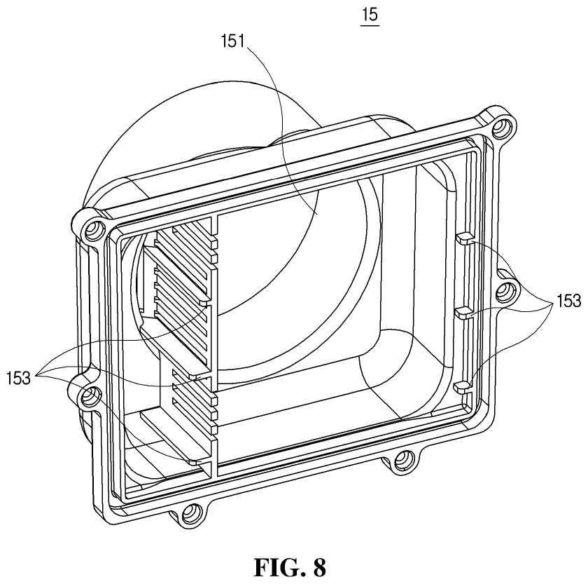

In other words, as shown in FIG. 8, the locking projection 153 is formed at a lower side of the upper cover 15 and prevents the head portion 35 from moving. The locking projection 153 is in contact with the head portion 35 of the grinding scraper 30 placed at the mounting position and prevents the grinding scraper 30 from turning in an opposite direction (see the direction of “C” in FIG. 6) to the mounting direction.

Therefore, the grinding scraper 30 is locked not to move in the mounting state by only coupling the upper cover 15 to the upper portion of the main body housing 11.

Meanwhile, the head portion 35 may have various shapes, and may include an inclined portion 351 provided at one side and shaped corresponding to an introducing portion 113 of the main body housing 11 as shown in FIGS. 3A-3B and 7.

The introducing portion 113 may, as shown in FIG. 7, be provided around the upper opening 111 and shaped to guide the food waste put into the upper portion of the main body housing 11 to be introduced toward the grinding blades 51.

In this case, as shown in FIG. 7, the head portions 35 of the grinding scrapers 30 are positioned at the opposite sides of the upper opening 111, and therefore connected to the introducing portion 113 by forming the inclined portion 351 in the head portion 35, thereby introducing the food waste to the grinding blades 51.

The scraper guide 17 is provided inside the housing 10, guides the grinding scraper 30 to turn to the mounting position, and supports the grinding scraper 30 in the mounting state.

The scraper guide 17 may be separately provided inside the main body housing 11, but may be variously provided as integrated with a transfer housing 19 or the like elements (see FIG. 5), as a part of the main body housing 11 (see an enlarged view of FIG. 5).

When two grinding blades 51 are provided, two left and right scraper guides 17 may be provided corresponding to the grinding scrapers 30 as shown in FIG. 5.

In this case, the scraper guides 17 may have the same shape based on the internal design of the main body housing 11, but may be different in shape from each other as described above.

A stopper 171 prevents the grinding scraper 30 from turning beyond the mounting position in the mounting direction.

The stopper 171 may be provided at various positions, for example, one of the lower end and center side of the body 31 or both of them.

There may be various kinds of stopper 171. For example, the stopper 171 may include a stopper projection 1711 provided in one of the body 31 and the scraper guide 17 corresponding to the body 31, and a stopper-projection accommodating groove 1713 provided in the other one and accommodating the stopper projection 1711.

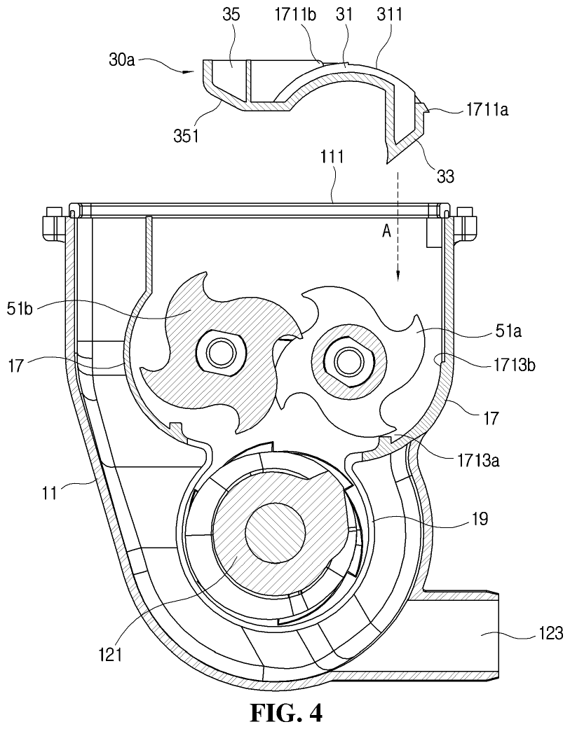

For example, referring to FIG. 4, a stopper projection 1711a may be formed in a lower end of the body 31 of the grinding scraper 30, and a stopper-projection accommodating groove 1713a may be provided at one side of a lower end of the scraper guide 17 corresponding to the stopper projection 1711a.

Thus, as shown in FIG. 5, when the grinding scraper 30 is turned in the mounting direction (see the direction of “B”) and reaches the mounting position, the stopper projection 1711a is accommodated in the stopper-projection accommodating groove 1713a and prevents the grinding scraper 30 from turning beyond the mounting position.

Alternatively, as shown in the enlarged view of FIG. 5, a stopper projection 1711b may be provided at one side in the middle of the back side 311 of the body 31 of the grinding scraper 30, and the stopper-projection accommodating groove 1713b may be provided at one side in the middle of the scraper guide 17 corresponding to the stopper projection 1711b.

Thus, in the food-waste disposal apparatus according to the disclosure, the grinding scraper is firmly locked in the state that the grinding scraper is mounted, because downward movement of the grinding scraper is restricted by the stopper and upward movement is restricted by the locking projection of the upper cover.

Below, it will be described with reference to FIGS. 4 to 7 that the grinding scraper 30 is mounted to and detached from the food-waste disposal apparatus 1 according to an embodiment of the disclosure.

First, a mounting process is as follows. As shown in FIG. 4, in a state that only the upper cover 15 is detached and all the elements including the grinder 50 are assembled, a grinding scraper 30a is horizontally laid on grinding blades 51a in the direction of “A” through the upper opening 111 of the main body housing 11 so that the scraper projections 33 can be disposed between the grinding blades 51a.

Next, as shown in FIG. 5, the laid grinding scraper 30a is pushed in the direction of “B” (i.e., the mounting direction) and turned to make the back side 311 of the body 31 of the grinding scraper 30 be turned along the guide surface 173 of the scraper guide 17. When the back side 311 of the body 31 of the grinding scraper 30 is turned up to the mounting position of FIG. 5, the stopper 171 prevents the grinding scraper 30a from additionally turning, and thus the grinding scraper 30a is settled on the mounting position.

Meanwhile, as shown in FIG. 5, an opposite grinding scraper 30b is also laid on grinding blades 51b in the direction of “A” and then mounted as turned in the mounting direction.

Next, as shown in FIG. 6, the upper cover 15 is mounted to the top of the main body housing 11 after both the grinding scrapers 30a and 30b are all mounted at the mounting positions. Then, the locking projections 153 are in contact with the head portions 35, thereby preventing the grinding scraper 30 from turning in a detaching direction (i.e., the direction of “C”).

Therefore, in the state that the upper cover 15 is coupled, the grinding scraper 30 is firmly locked because its downward movement is prevented by the stopper 171 and its upward movement is prevented by the locking projection 153.

Meanwhile, a process of detaching the grinding scraper 30 is as follows. As shown in FIG. 7, in a state that the upper cover 15 is detached from the main body housing 11, the head portion 35 of the grinding scraper 30 is turned in a detaching direction (see the direction of “C” in FIG. 6) until the grinding scraper 30b is laid on the grinding blades 51b as shown in “30b” in FIG. 5. Then, it is possible to detach the grinding scraper 30b through the upper opening 111.

Therefore, a food-waste disposal apparatus according to the disclosure has advantages that it is easy to mount and detach the grinding scraper and it is possible to minimize time taken in mounting and detaching the grinding scraper because a grinding scraper is mountable and detachable without disassembling any element other than an upper cover, and a separate process or effort to lock the grinding scraper is not needed because the grinding scraper is firmly locked by coupling only the upper cover.

According to the disclosure, there is provided a food-waste disposal apparatus, in which it is easy to mount and detach the grinding scraper and it is possible to minimize time taken in mounting and detaching the grinding scraper because a grinding scraper is mountable and detachable without disassembling any element other than an upper cover, thereby maximizing convenience.

Further, according to the disclosure, there is provided a food-waste disposal apparatus, in which downward movement of a grinding scraper is restricted by a stopper and upward movement of the grinding scraper is restricted by a locking projection of an upper cover as long as the upper cover is coupled in a state that the grinding scraper is mounted, thereby firmly locking the grinding scraper without any separate process for the locking.

Although a few embodiments have been shown and described, it will be appreciated by those skilled in the art that various changes and modifications can be made in these embodiments without departing from the principles and spirit of the invention, the scope of which is defined in the appended claims and their equivalents.

What is claimed is:

1. A food-waste disposal apparatus comprising:
a housing;
a plurality of grinding blades provided inside the housing and grinding food waste put into the housing;
a grinding shaft mounted with the plurality of grinding blades at setting intervals and rotatably installed at one side of the housing;
a grinding scraper comprising a plurality of scraper projections and preventing food waste from getting stuck between the grinding blades; and
a scraper guide provided inside the housing, guiding the grinding scraper to turn to a mounting position, and supporting the grinding scraper in a mounting state,
wherein the grinding scraper is mounted at the mounting position as turned along the scraper guide after the grinding scraper is laid on the grinding blades through an upper opening of the housing so that the scraper projections can be disposed between the grinding blades, or detached from the mounting state as turned in a reverse direction.

2. The food-waste disposal apparatus of claim 1, wherein
the grinding scraper comprises a body, and the plurality of scraper projections extended from the body, and
a back side of the body facing the scraper guide is shaped corresponding to a guide surface of the scraper guide at the mounting position.

3. The food-waste disposal apparatus of claim 2, further comprising a stopper at one side of the scraper guide to prevent the grinding scraper from turning beyond the mounting position in a mounting direction.

4. The food-waste disposal apparatus of claim 3, wherein
the grinding scraper further comprises a head portion formed in an upper portion of the body facing the upper opening in the mounting state,
the food-waste disposal apparatus further comprises an upper cover formed with a food-waste inlet at an upper side, communicating with the upper opening, and detachably coupled to the upper opening of the housing so that food waste can be introduced into the housing, and
the upper cover comprises a locking projection at a lower side to prevent the head portion from moving, and prevents the grinding scraper from turning at the mounting position in a detaching direction.

5. The food-waste disposal apparatus of claim 4, wherein
the housing comprises an introducing portion formed at one side of the upper opening and inclined to facilitate introduction of food waste into the grinding blades, and
the head portion is formed with an inclined portion shaped corresponding to the introduction portion at the mounting position, and connected to the introducing portion in a state that the grinding scrapper is mounted.

6. The food-waste disposal apparatus of claim 1, wherein
the grinding shaft comprises two left and right grinding shafts provided inside the housing, and
the scraper guide and the grinding scraper are respectively provided corresponding to the grinding shafts.

7. The food-waste disposal apparatus of claim 6, wherein the scraper guides comprise guide surfaces different in shape from each other, and the grinding scrapers comprise back sides respectively provided corresponding to the guide surfaces.

8. The food-waste disposal apparatus of claim 3, wherein the stopper is provided in one or both of a lower end and a middle side of the body.

9. The food-waste disposal apparatus of claim 8, wherein the stopper comprises a stopper projection provided in one of the body and the scraper guide corresponding to the body, and a stopper-projection accommodating groove provided in the other one and accommodating the stopper projection.

10. The food-waste disposal apparatus of claim 2, wherein
the body comprises a front side facing the grinding blade and shaped like an arc to prevent interference with the grinding blade, and the back side shaped corresponding to the guide surface, and
the plurality of scraper projections protrudes from a lower side of the body toward the grinding blade.
